(19) United States
(12) Patent Application Publication
(10) Pub. No.: US 2017/0242539 A1
(43) Pub. Date: Aug. 24, 2017

(54) USE BASED FORCE AUTO-CALIBRATION

(71) Applicant: Synaptics Incorporated, San Jose, CA (US)

(72) Inventor: Sanjay Mani, Santa Clara, CA (US)

(21) Appl. No.: 15/199,756

(22) Filed: Jun. 30, 2016

Related U.S. Application Data
(60) Provisional application No. 62/297,117, filed on Feb. 18, 2016.

(51) Int. Cl. G06F 3/041; G06F 3/044

(52) U.S. Cl. CPC G06F 3/0418; G06F 3/044; G06F 2203/04108; G06F 2203/04105

(57) ABSTRACT

A processing system for an input device, the processing system including sensor circuitry communicatively coupled to a plurality of position sensor electrodes and a plurality of force sensor electrodes, and a sensor module with circuitry. The sensor module is configured to acquire a plurality of changes in capacitance from the plurality of force sensor electrodes, which occurs in response to a deflection of the sensor electrodes by an input force. The system also includes a determination module configured to determine a force level based on the plurality of changes in capacitance of the force sensor electrodes, analyze the force level to update a force threshold based on the analysis, determine whether a current force level associated with the sensor electrodes exceeds the updated force threshold, and assign a force status to the input object based on the determination of whether the current force level exceeds the updated force threshold.

### CROSS REFERENCE TO RELATED APPLICATIONS

This application claims benefit under 35 U.S.C. 119(e) to U.S. Provisional Application No. 62/297,117, filed on Feb. 18, 2016, which is incorporated by reference herein in its entirety.

### FIELD

This invention generally relates to electronic devices.

### BACKGROUND

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, the invention relates to a processing system for an input device, the processing system comprising sensor circuitry communicatively coupled to a plurality of position sensor electrodes and a plurality of force sensor electrodes, a sensor module comprising circuitry configured to: acquire a plurality of changes in capacitance from the plurality of force sensor electrodes, wherein the plurality of changes in capacitance occurs in response to a deflection of the plurality of sensor electrodes by an input force, and wherein the input force is applied by an input object to an input surface of the input device, and a determination module configured to: determine a force level based on the plurality of changes in capacitance of the plurality of force sensor electrodes, analyze the force level to update a force threshold based on the analysis, determine whether a current force level associated with the plurality of sensor electrodes exceeds the updated force threshold, and assign a force status to the input object based on the determination of whether the current force level exceeds the updated force threshold.

In general, in one aspect, the invention relates to a method for auto-calibrating an input device, comprising acquiring a plurality of changes of capacitance from a plurality of force sensor electrodes, determining a force level based on the plurality of changes in capacitance of the plurality of force sensor electrodes, analyzing the force level to update a force threshold based on the analysis, detecting an input object in a sensing region of the input device comprising the plurality of force sensor electrodes, determining whether a current force level associated with the input object exceeds the updated force threshold, and assigning a force status to the input object based on the determination.

In general, in one aspect, the invention relates to an input device comprising an input surface, a plurality of force sensor electrodes, and a processing system comprising circuitry configured to: acquire a plurality of changes of capacitance at the plurality of force sensor electrodes, determining a force level based on the plurality of changes in capacitance of the plurality of force sensor electrodes, analyze the force level to update a force threshold based on the analysis, detect an input object in a sensing region of an input device comprising the plurality of sensor electrodes, determine whether a current force level associated with the input object exceeds the updated force threshold, and assign a force status to the input object based on the determination of whether the current force level exceeds the updated force threshold.

Other aspects of the invention will be apparent from the following description and the appended claims.

### BRIEF DESCRIPTION OF DRAWINGS

FIG. 1 shows a block diagram in accordance with one or more embodiments.

FIG. 2 shows a schematic diagram in accordance with one or more embodiments.

FIG. 3 and FIG. 4 show flowcharts in accordance with one or more embodiments.

FIG. 5 shows an example in accordance with one or more embodiments.

FIG. 6.1 and FIG. 6.2 show example graphs in accordance with one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments provide input devices and methods that facilitate improved usability. In particular, one or more embodiments are directed to calibrating force sensors based on a user's use of a touch device. Specifically, the use of a device can change the mechanical or electrical properties of the system such that the range of force values registered by the force sensors may change over time, resulting in fixed thresholds or ranges that may be incorrect. Embodiments of the invention auto-calibrate the force values registered by the force sensors and adjust the thresholds/ranges while the device is in-use.

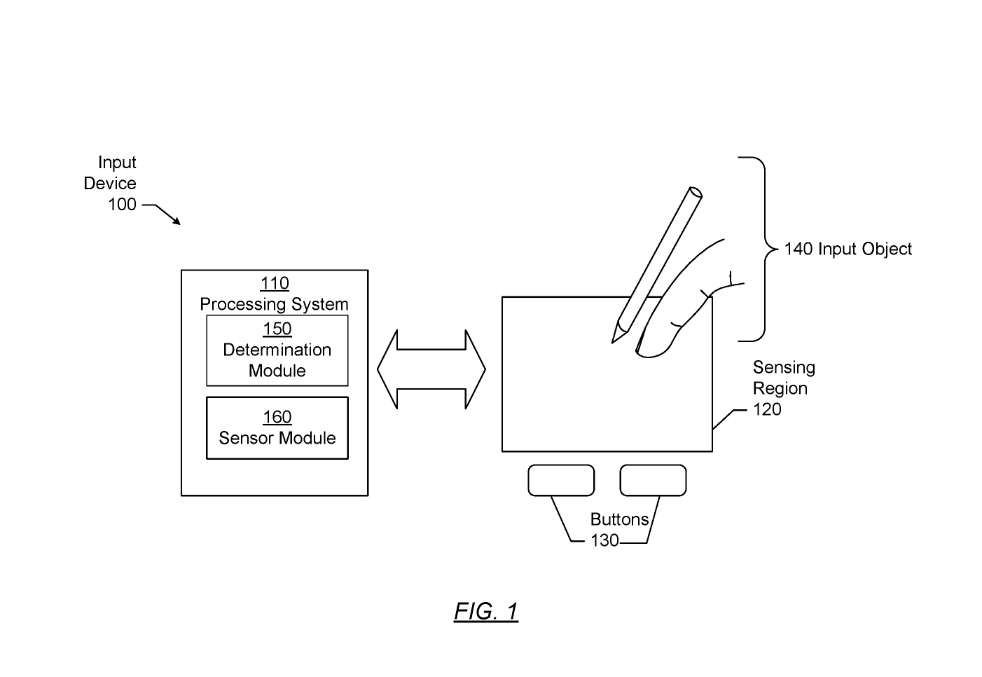

Turning now to the figures, FIG. 1 is a block diagram of an exemplary input device (100), in accordance with embodiments of the invention. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. Further, portions of the input device (100) as part of the electronic system. For example, all or part of the determination module may be implemented in the device driver of the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad” or a “touch sensor device”) configured to sense input provided by one or more input objects (140) in a sensing region (120). Example input objects include fingers and styli, as shown in FIG. 1. Throughout the specification, the singular form of input object is used. Although the singular form is used, multiple input objects exist in the sensing region (120). Further, which particular input objects are in the sensing region may change over the course of one or more gestures. For example, a first input object may be in the sensing region to perform the first gesture, subsequently, the first input object and a second input object may be in the above surface sensing region, and, finally, a third input object may perform the second gesture. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device may be referred to as the above surface sensing region. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes. Further, some implementations may be configured to provide a combination of one or more images and one or more projections.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitance implementations of the input device (100), voltage or current is applied to create an electric field. Nearby input objects cause changes in the electric field, and produce detectable changes in capacitive coupling that may be detected as changes in voltage, current, or the like.

Some capacitance implementations utilize arrays or other regular or irregular patterns of capacitive sensing elements to create electric fields. In some capacitance implementations, separate sensing elements may be ohmically shorted together to form larger sensor electrodes. Some capacitance implementations utilize resistive sheets, which may be uniformly resistive.

Some capacitance implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may by a substantially constant voltage or a varying voltage and in various embodiments; the reference voltage may be system ground. Measurements acquired using absolute capacitance sensing methods may be referred to as absolute capacitive measurements.

Some capacitance implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals (also called “sensing signal”). Receiver sensor electrodes may be held substantially constant relative to the reference voltage to facilitate receipt of resulting signals. The reference voltage may by a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g. other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of or all of one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, identify a gesture, determine an action to perform based on the gesture, a combination of gestures or other information, and/or perform other operations. The determination module (150) may be implemented as a processor and associated memory.

The sensor module (160) may include functionality to drive the sensing elements to transmit transmitter signals and receive the resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

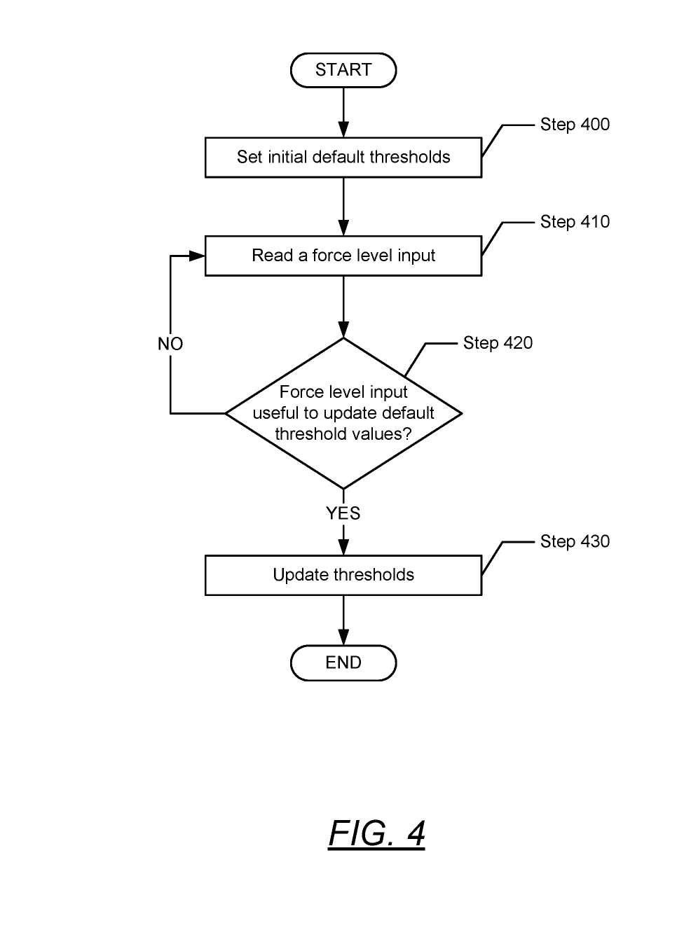

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions. In one or more embodiments, the electronic system includes one or more components as described in FIGS. 4.1 and 4.2.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, determine force information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

“Force information” as used herein is intended to broadly encompass force information regardless of format. For example, the force information may be provided for each object as a vector or scalar quantity. As another example, the force information may be provided as an indication that determined force has or has not crossed a threshold amount. As other examples, the force information can also include time history components used for gesture recognition. As will be described in greater detail below, positional information and force information from the processing systems may be used to facilitate a full range of interface inputs, including use of the proximity sensor device as a pointing device for selection, cursor control, scrolling, and other functions.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may configured for both display updating and input sensing. As another example, the display screen may be operated in part or in total by the processing system (110).

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media that is readable by the processing system (110)). Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer readable storage medium. Examples of non-transitory, electronically readable media include various discs, physical memory, memory, memory sticks, memory cards, memory modules, and or any other computer readable storage medium. Electronically readable media may be based on flash, optical, magnetic, holographic, or any other storage technology.

Although not shown in FIG. 1, the processing system, the input device, and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores, or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

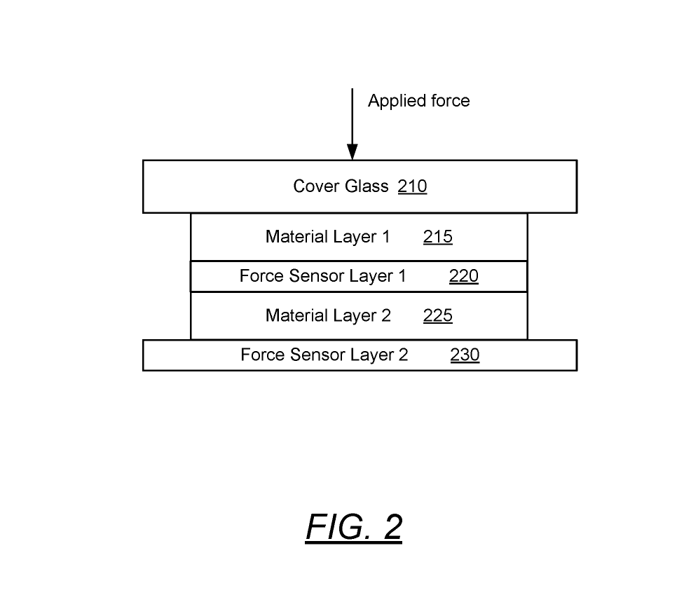

FIG. 2 shows an example stack-up having multiple layers including a cover glass (210) layer on the top, two material layers (215, 225), and two force sensing layers (220, 230). On the bottom side of the cover glass (210) is material layer 1. Material layer 1 (215) may be, for example, a display, foam, compressible OCA, or any other suitable material. In one or more embodiments of the invention, the force sensor layer 1 (220) is positioned on the top side of a compressible material layer 2 (225). Force sensor layer 2 (230) is positioned on the bottom side of material layer 2 (225). Material layer 2 (225) may also be foam, or a combination of foam and air, a display, or any other suitable pliable material. More specifically, compressible material layer 2 may be implemented as a closed cell or open cell foam structure, structured silicon, or any other chemical composition and/or mechanical construction which exhibits transient elastic deformation in response to applied pressure. In one or more embodiments, force is sensed by compression between the two force sensor layers 1 and 2 (220, 230).

In one or more embodiments, force sensor layer 1 (220) has N electrodes, and force sensor layer 2 (230) is a ground plane. The N electrodes are connected to a capacitive measurement integrated circuit (IC) that produces N capacitive measurements. This is known as absolute capacitive sensing. In an alternative embodiment, the N electrodes of force sensor layer 1 (220) may be used as receiver electrodes, and force sensor layer 2 (230) may be driven as transmitter electrodes. This is known as trans-capacitive sensing. Both configurations may measure the change in thickness in the compressible layer (material layer 2 (225)), and convert the change in thickness into a capacitance value. Force or applied pressure on the top of the stack-up, on the cover glass (220), may generate the compression.

Those skilled in the art will appreciate that the force sensing stack up shown in FIG. 2 may have different configurations without departing from the scope of the invention. For example, the force sensing electrodes of layer 1 (220) may be integrated with material layer 1 (215). In this case, material layer 1 (215) may be the display. Alternatively, the force sensing electrodes may be on a single layer, or there may be more than two layers of force sensing electrodes in the stack-up. For example, in one embodiment, the sensor electrodes of force sensing layer 1 220 may be arranged on different sides of the same substrate. In other embodiments, the sensor electrodes of force sensing layer 1 220 may be arranged on different substrates. In another embodiment, the sensor electrodes of force sensing layer 1 220 are all located on the same side or surface of a common substrate. In one example, a first plurality of the sensor electrodes include jumpers in regions where the first plurality of sensor electrodes crossover a second plurality of sensor electrodes, where the jumpers are insulated from the second plurality of sensor electrodes.

In one or more embodiments of the invention, due to variation in the mechanical and electrical parameters of the system, the conversion of the N sensor measurements into useful force values for applications to employ may involve setting (calibrating) thresholds, and these thresholds may change with use requiring updates to the thresholds.

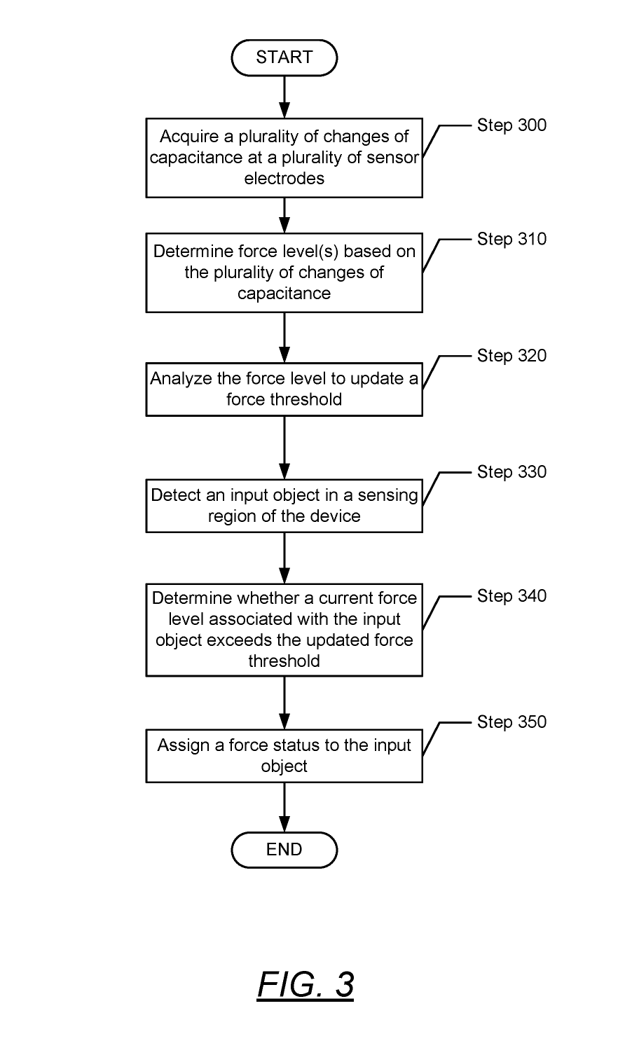

FIG. 3 shows a flow chart for auto-calibration of such thresholds, in accordance with one or more embodiments of the invention. In one or more embodiments, one or more of the steps shown in FIG. 3 may be omitted, repeated, and/or performed in a different order than the order shown in FIG. 3. Accordingly, the scope of embodiments disclosed herein should not be considered limited to the specific arrangement of steps shown in FIG. 3.

Initially, in Step 300, a plurality of changes of capacitance at a plurality of sensor electrodes is acquired. Specifically, an input object may apply pressure on the cover glass shown in FIG. 2. The applied pressure causes changes in capacitance of the plurality of sensor electrodes in force sensor layers 1 and 2 (discussed above in FIG. 2). More specifically, in one or more embodiments of the invention, the plurality of changes of capacitance occurs in response to a deflection of the plurality of sensor electrodes by an input force applied by the input object. In one or more embodiments, the deflection may be a mechanical deflection between the transmit and receive electrodes in the trans-capacitive force stack up. Those skilled in the art will appreciate that the type of deflection and between which layers the deflection occurs may vary depending on the stack up that is employed.

Continuing with FIG. 3, in Step 310, a force level is determined based on the plurality of changes of capacitance detected. Specifically, the mechanical deflection caused by force applied by the input object causes the distance between the capacitive sensor and a grounded plane to change. This causes a change in the capacitive sensor reading, which is sampled. Based on mathematical manipulation of the sampled values, a force level is determined. In one or more embodiments of the invention, a single force level may be determined for all the plurality of changes in capacitance. That is, the plurality of changes in capacitance may be summed or combined in any other suitable manner to determine a single force level across the plurality of sensor electrodes.

In addition, in one or more embodiments of the invention, the force level may also be dependent on positional information (x, y; denoting the coordinate position of the input object in the sensing region of the input device). Accordingly, the force level determined in Step 310 may be based on the positional information of the input object in combination with the plurality of changes in capacitance of the plurality of force sensor electrodes.

More specifically, in Step 310, if a sensor reading is S(i, t), where i represents a sensor index from 1 to N, taken at time t, and the finger position for each finger or object j is (xⱼ, yⱼ) also taken at the same time t, those of ordinary skill in the art would appreciate that the N electrode readings and j finger positions may be combined using a suitable mathematical function Fj (S(i, t), xⱼ, yⱼ, t) to obtain the force level. One such suitable mathematical function may be a summation of the plurality of individual sensor readings. Alternatively, the individual sensor readings may be combined using an average function, a weighted average function, a linear fit algorithm, a least squares minimization, a general fitting algorithm, any combination of these functions, etc. In one or more embodiments of the invention, the result of the combined sensor readings is a per finger/object force level.

Those skilled in the art will appreciate that the sensor reading S(i, t) may be a single sample (trans-capacitance, for example) or may be converted into a new value SL(i, t) using both the sampled value and a value created by subtracting this sample from a stored reference value (trans-capacitance baseline, for example). The sensor force level may then be derived from the new sensor level as Fj (SL(i, t), xⱼ, yⱼ, t). The individual sensor reading S(i) is a monotonic function increasing with force, as is the final calculated force level F. Further, those skilled in the art will appreciate that sensor sample values may be taken to minimize error and false positives. For example, only presses within some small distance of the sensor position may be used.

In one or more embodiments of the invention, the force level obtained in Step 310 is a value for the force being applied by a single object (e.g., a finger or a stylus) putting pressure on the input device. In one or more embodiments of the invention, when there is more than one object putting pressure on the input device, multiple force levels may be obtained, where one force level corresponds to one of the objects applying pressure on the device.

In Step 320, the force level is analyzed to update a force threshold. Specifically, in one or more embodiments of the invention, the force level obtained in Step 310 may be compared to previously determined initial (default) force thresholds to determine whether the force thresholds require adjustment. Force thresholds may include, but are not limited to, a threshold beneath which a press is not being activated by the user of the input device (i.e., a touch threshold), a threshold above which force is being applied by the user, and a maximum force press being applied by the user. Step 320 is described in further detail below in FIG. 4. In one or more embodiments of the invention, the force thresholds are used to calibrate the force signal for use by higher level applications, such as games.

In Step 330, which may occur at some later point in time after Step 320, an input object is detected in a sensing region of the input device. For example, a finger of a user or stylus object may be detected as touching or applying pressure in a sensing region of the input device. In Step 340, a current force level associated with the input object is determined. In one or more embodiments of the invention, the current force level of the input object may be different from the force level determined in Step 310. Subsequently, it is determined whether this current force level of the input object exceeds the updated force threshold obtained in Step 320. In Step 350, a force status is assigned to the input object. For example, if the force threshold for a touch threshold is calibrated at a value of 220 in Step 320, and the input object applies a force greater than 220 in Step 340, then the input object may be assigned a force status of ‘force press’ in Step 350.

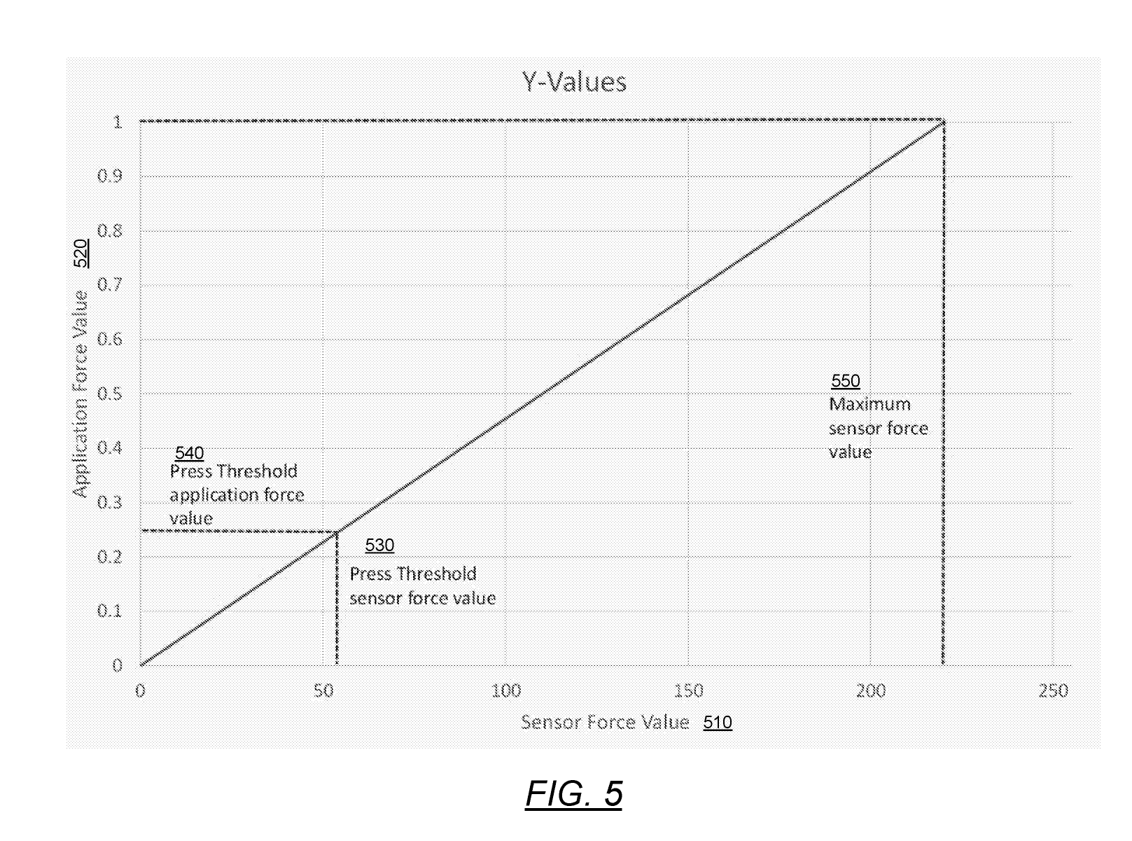

Although not shown in FIG. 3, those skilled in the art will appreciate that the force status assigned in Step 350 may be reported to a host device, for example, from the touch controller ASIC to the operating system (OS). Based on the reported force status, the OS may perform some action. For example, in one or more embodiments of the invention, the reported force status may be used to drive an action in a higher level application, such as a game that is being executed on the input device. For example, based on the force status reported as a maximum force press, an executing game may accelerate an object at its maximum acceleration value. The application of the force thresholds is discussed in further detailed in FIG. 5.

Turning to FIG. 4, in one or more embodiments of the invention, FIG. 4 describes a continuous process for calibrating force thresholds while the input device is in use, in accordance with one or more embodiments of the invention. Specifically, FIG. 4 describes the steps required to analyze the force level and update force thresholds as described in Step 320 of FIG. 3.

In one or more embodiments of the invention, in Step 400, initial (default) force thresholds are set. Initial thresholds may be set per unit in calibration, or a representative sample or set of samples may be analyzed, and all units may subsequently be set to the threshold values determined for the sample set. In one or more embodiments of the invention, there may be at least two default force thresholds—a ‘press’ threshold for typical binary force applications where either force is being applied or is not being applied, and a maximum pressure threshold for typical continuous force applications. The ‘press’ threshold may determine, for example the difference between a touch input and a force input. Thus, for example, when an object applies pressure in a sensing area of an input device, if the applied force is above the ‘press’ threshold, then it is determined that the object is applying force rather than simply providing a touch input. In contrast, when the applied force is below the ‘press’ threshold, then it is determined that the input is a touch input. The maximum pressure threshold represents the maximum pressure that can be applied across one or more force sensing electrodes.

Depending on the degree of accuracy required, there may be more than one way in which to set the initial force thresholds. For example, in one embodiment of the invention, to set the initial press threshold, the sensor force level data on a representative input device may be analyzed when a user is not employing force. This may require communication of information between the device (e.g., host device such as a smartphone, tablet, laptop, or any other suitable touch input device) and the calibration algorithm executing on a touch/force controller ASIC or similar hardware). In one or more embodiments of the invention, the host device may be separate from the input device, and information regarding use of force or lack thereof may be communicated between such a third host device to the input device. The data may be statistically analyzed for standard deviation, for example, and the threshold may be set to a desired amount of standard deviation above this value. The same data (when a user is not employing force) may also be analyzed for the highest value, and the push/press threshold may be set to slightly above this highest value.

In an alternative embodiment, the device may inform the algorithm when a force-enabled application is being used, acquire data, and build a histogram. The use threshold may be set at a fixed percentage, such as 50% of the cumulative distribution function. In yet another embodiment, the algorithm may detect when the user is not trying to engage a force application, via various statistical tests on the force samples, and then acquire data for analysis to determine the ‘press’ threshold. For example, detection of the user not trying to use force may occur when there are no values within some small percentage of the maximum force threshold, or no detections above the current force “press” threshold for a certain amount of time.

Continuing with Step 400, in one or more embodiments, a maximum pressure threshold may be set by analyzing the sensor force level data when the user is trying to apply force. For example, the maximum pressure force level may be taken as a user employs a force enabled application using the force sensor. In this case, the device may be configured to inform the algorithm when a force-enabled application is being used and then the maximum force level employed over the last time interval (e.g., 24 hours) may be stored. Alternately, a force sensor electrode may have a maximum force that the sensor is able to accept. In this case, this known maximum force may be applied to a representative unit, the force sensor level reading recorded, and then used for all units.

In yet another embodiment, initial (default) force thresholds may be factory set, at the time of manufacture of the device. In this scenario, the default force thresholds may be based on educated guesses by manufacturers of the devices. In one or more embodiments of the invention, the initial (default) force thresholds may be stored on the input device.

Those skilled in the art will appreciate that although Step 400 is focused on two key threshold measurements, embodiments of the invention may apply to more than only two force thresholds. For example, there may be intermediate force thresholds between the ‘press’ threshold and the maximum pressure threshold that may be initially determined and auto-calibrated. More specifically, an application which requires a 3-level force scheme may exist, where there may be thresholds for touch, a light press (with application of light force) and a heavy press, that require auto-calibration. Thus, there may be any number of force thresholds

Further, those skilled in the art will appreciate that the invention is not limited to the aforementioned example methods for determining the initial force thresholds. Indeed, the initial force thresholds may be determining in a variety of suitable alternate ways without departing from the scope of the invention. For example, the ‘press’ threshold may be set by simply using a fixed fraction of difference between ‘zero’ force value and maximum force value. Specifically, the ‘press’ threshold may be, for example, 33% of the difference between ‘zero’ force value and a known or estimated maximum force value. In one or more embodiments, the fixed percentage chosen may be determined by user studies. In another example, the ‘press’ threshold may be determined without informing the algorithm when force is being used on the device. In this case, the algorithm may acquire and store sub-sampled sensor data obtained periodically (for example, every 1 second). Data outlier rejection may be performed on the first set of sample data, and then the mean of the remaining data may be obtained. A standard deviation may be pre-stored for the use case when the user is not intending to ‘press’, and this standard deviation may be used to set a ‘press’ threshold some number of these standard deviations above the calculated mean.

Once the key thresholds are set initially in the device, according to one or more embodiments, the auto-calibration method disclosed herein is configured to update the sensor force thresholds as used by the application force as needed. In Step 410, a force level input is read. Specifically, while the device is in use, a current force level applied by an input object is determined. As described above, the force level input may include positional information resulting from a touch input in a sensing region of the device.

In Step 420, a determination is made as to whether the current force level that is read by the device is useful to update the initial (default) force thresholds. Specifically, in one or more embodiments of the invention, a current force level read by the device may trigger the adjustment of one or more of the initially determined force levels when the initially determined force levels have depleted over time due to wear on the sensor electrodes. For example, consider the scenario in which the initial ‘press’ threshold is set at a value slightly above the highest value recorded when a user is not applying force on the device. However, over time, suppose that initial ‘press’ threshold requires more stress applied than when the device was new. In this case, the calibration of the initial ‘press’ threshold would be adjusted using the process of FIG. 4. For example, when a user indicates that an application requiring force is being used, the ‘press’ threshold may be recalibrated when the algorithm determines that the initial or previously determined ‘press’ threshold is not being met by the stress applied by the user when the user wants to apply force.

Alternatively, in one or more embodiments, an initially determined maximum pressure threshold may require adjustment when the stored maximum pressure threshold is exceeded by a user applying force on the device. For example, suppose a maximum pressure threshold is set as a factory default setting at a particular value. When a user playing a game, for example, on the input device applies maximum continuous force, and that force level calculated during use of the device exceeds the stored factory default setting, the maximum pressure threshold may require adjustment to reflect the new maximum read by the device. In this case, when the maximum pressure threshold value is exceeded by a current measured maximum force level, the maximum pressure threshold value is updated to be equal to the current measured force level.

If the current force level that is read by the device is useful to update the initial (default) force thresholds (Step 420), then one or more of the stored force thresholds are updated in Step 430. Alternatively, if the force level input read by the device is not useful to update the initial (default) force thresholds (Step 420), then the process returns to Step 410 to wait for another force level input. Those skilled in the art will appreciate that the process shown in FIG. 4 does not end because it is a continuous auto-calibration process that runs in the background while the device is in use.

Those skilled in the art will appreciate that some of the methods used to set the initial threshold (Step 400) may also be used to update the threshold (Step 430).

In one or more embodiments of the invention, in order for the sensor force level Fⱼ determined in Step 310 of FIG. 3 to be of use to a higher level application, the sensor force level may be converted into a force value an application can use, Aⱼ. Specifically, the purpose of embodiments disclosed herein is to set key thresholds or calibration points in sensor force units, which allows conversion into application force units. FIG. 5 shows an example of one way in which to convert the sensor force level to an application force value, in accordance with one or more embodiments of the invention.

In FIG. 5, a linear graph mapping sensor force value (510) to application force value (520) is shown. In the example of FIG. 5, with no force applied, the application force value should be zero, which may be captured when no input object is touching the sensing region on the input device. The maximum sensor force threshold (550) is determined in one or more of the ways described above. Accordingly, once these two points are known, a linear graph connecting the two known points on a line may be drawn to obtain the scale shown in FIG. 5. In one or more embodiments, the example of FIG. 5 assumes the sensor force value is a multi-level value, either continuous (e.g., float between 0 and 5.0) or discrete (e.g., integer between 0 and 1023). In the example shown, the application force value (520) is reported in a normalized float between 0.0 and 1.0, and the sensor force value (510) is selected to be integer an integer value between zero and 250.

The ‘press’ threshold may be implemented either by reporting a press when the sensor force value F (510) is greater than a threshold (as described above in FIG. 3 and FIG. 4), or by mapping the sensor force value to an application value A (520), and then reporting when A is over a threshold, as shown in FIG. 5. In the linear graph of FIG. 5, the ‘press threshold’ (540) is mapped to a sensor force value of 52 (530), and the maximum pressure threshold is mapped to a maximum sensor force value of 220 (550).

The linear graph of FIG. 5 may be used to interpolate force values between the ‘press threshold’ (540) and the maximum sensor force threshold (550). For example, using the scale shown in FIG. 5, any value between the ‘press’ threshold of 52 (530) and the maximum sensor force value of 220 (550) may be interpolated to obtain some application force value between the two force thresholds. For example, using the scale of FIG. 5, a sensor force value of 100 maps to an application force value of 0.45.

Those skilled in the art will appreciate that for an application requiring a continuous application force value, like accelerating a car where pushing harder yields more acceleration, the sensor force value F (510) may be mapped between its minimum value (e.g., 0) and its maximum value (550) to the application force value A, as illustrated in FIG. 5. Further, those skilled in the art will appreciate that A, need not be an absolute accurate force value, as long as it supports the user experience.

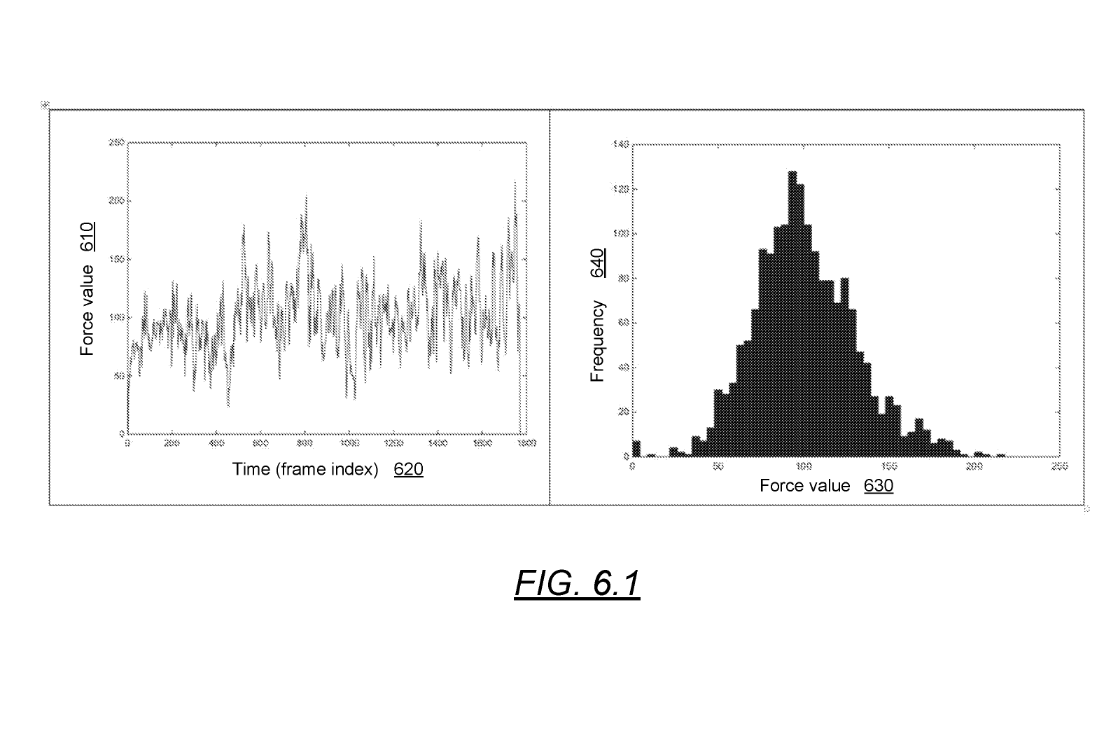

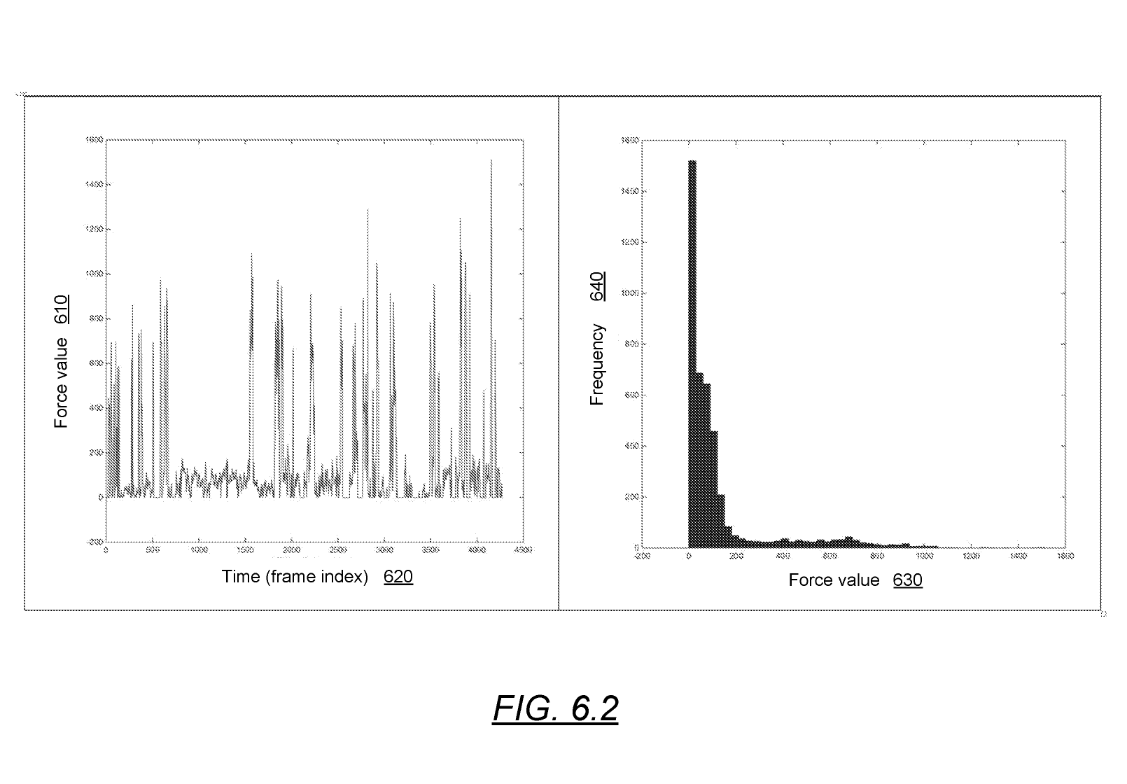

Examples of sensor force level data are illustrated in FIGS. 6.1 and 6.2, in accordance with one or more embodiments of the invention. Specifically, FIG. 6.1 shows sensor force level data (610) captured over time (620) when a user is touching the sensor but not actively using force. A histogram on the right hand side of FIG. 6.1 shows the distribution of force values (630) obtained when the user is not actively using force.

FIG. 6.2 shows a sample set of sensor force values (610) vs. time (620), when the user is actively using an application requiring force to be applied. For example, when the user is playing a video game requiring acceleration by application of force. The histogram on the right side of FIG. 6.2 shows the frequency (640) of each force value recorded. Thus, for example, the force value of zero was observed most frequently.

In one or more embodiments of the invention, the sample sensor force level data as shown in FIG. 6.2 may be used to update/adjust the maximum pressure force threshold. Specifically, in one or more embodiments, the input device may inform the algorithm when a force enabled application is being used and detect the force use ‘spikes’ as seen in FIG. 6.2 and store the peak values. This detection may be performed by running a matched filter, or derivative based peak detection, and the peak values may be stored when they are within some percent of the current maximum, or some criteria greater than the average value in force units.

Embodiments disclosed herein describe a use-based auto-calibration approach that is only dependent on the capacitive signal response from the plurality of force sensing electrodes, rather than the electrical and mechanical system impacts on the translation of force to sensor value. That is, embodiments of the invention provide an approach to continuously updating the mathematical conversion parameters and key thresholds needed to accurately convert the change in capacitance sensor reading to the determined force level. As long as the sensor response is monotonic with force, then the force response may be calibrated. Critically, embodiments of the invention use the force samples to estimate the threshold beneath which a press is not being activated by the user, as well as samples indicating maximum force press. These thresholds are then used to calibrate the force signal for use by higher level applications (such as games). Thus, embodiments of the invention are able to auto-calibrate the force thresholds while the input device is in use, even when the relationship between force and the sensor reading is not a linear relationship.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. A processing system for an input device, the processing system comprising:
sensor circuitry communicatively coupled to a plurality of position sensor electrodes and a plurality of force sensor electrodes;
a sensor module comprising circuitry configured to:
acquire a plurality of changes in capacitance from the plurality of force sensor electrodes,
wherein the plurality of changes in capacitance occurs in response to a deflection of the plurality of sensor electrodes by an input force, and
wherein the input force is applied by an input object to an input surface of the input device; and
a determination module configured to:
determine a force level based on the plurality of changes in capacitance of the plurality of force sensor electrodes,
analyze the force level to update a force threshold based on the analysis,
determine whether a current force level associated with the plurality of sensor electrodes exceeds the updated force threshold, and
assign a force status to the input object based on the determination of whether the current force level exceeds the updated force threshold.

2. The processing system of claim 1, wherein updating the force threshold is based on data received from a host device.

3. The processing system of claim 1, wherein the force threshold is a press threshold.

4. The processing system of claim 1, wherein the determination module is further configured to receive an indication that the force level is acquired from a user using the input device for a non-force touch designated purpose.

5. The processing system of claim 1, wherein the force threshold is a maximum force value.

6. The processing system of claim 5, wherein the maximum force value is updated responsive to the at least one force level exceeding a current maximum force value.

7. The processing system of claim 1, wherein:
the sensor module further comprises circuitry configured to acquire, from the plurality of position sensor electrodes, positional information of the input object in a sensing region of the input device, and
the determination module is further configured to determine the force level based on the positional information of the input object in combination with the plurality of changes in capacitance of the plurality of force sensor electrodes.

8. A method for auto-calibrating an input device, comprising:
acquiring a plurality of changes of capacitance from a plurality of force sensor electrodes;
determining a force level based on the plurality of changes in capacitance of the plurality of force sensor electrodes;
analyzing the force level to update a force threshold based on the analysis;
detecting an input object in a sensing region of the input device comprising the plurality of force sensor electrodes;
determining whether a current force level associated with the input object exceeds the updated force threshold; and
assigning a force status to the input object based on the determination.

9. The method of claim 8, further comprising:
acquiring, from a plurality of position sensor electrodes, positional information of the input object in a sensing region of the input device; and
determining the force level based on the positional information of the input object in combination with the plurality of changes in capacitance of the plurality of force sensor electrodes.

10. The method of claim 8, wherein the auto-calibration method is performed while the input device is in use by a user.

11. The method of claim 8, wherein the force threshold is a maximum force value.

12. The method of claim 11, wherein the maximum force value is updated responsive to the at least one force level exceeding a current maximum force value.

13. The method of claim 8, wherein the force threshold is a press threshold.

14. The method of claim 8, further comprising:
receiving an indication that the force level is acquired from a user using the input device for a non-force touch designated purpose.

15. The method of claim 8, wherein updating the force threshold is based on data received from a host device.

16. An input device, comprising:
an input surface;
a plurality of force sensor electrodes; and
a processing system comprising circuitry configured to:
acquire a plurality of changes of capacitance at the plurality of force sensor electrodes,
determining a force level based on the plurality of changes in capacitance of the plurality of force sensor electrodes,
analyze the force level to update a force threshold based on the analysis,
detect an input object in a sensing region of an input device comprising the plurality of sensor electrodes,
determine whether a current force level associated with the input object exceeds the updated force threshold, and
assign a force status to the input object based on the determination of whether the current force level exceeds the updated force threshold.

17. The input device of claim 16, further comprising:
a plurality of position sensor electrodes, wherein the processing system further comprises circuitry configured to:
acquire, from the plurality of position sensor electrodes, positional information of the input object in a sensing region of the input device, and
determine the force level based on the positional information of the input object in combination with the plurality of changes in capacitance of the plurality of force sensor electrodes.

18. The input device of claim 16, wherein updating the force threshold is based on data received from a host device.

19. The input device of claim 16, wherein the force threshold is one selected from a group consisting of a maximum force value and a press threshold.

20. The input device of claim 19, wherein the maximum force value is updated responsive to the at least one force level exceeding a current maximum force value.
